(19) United States
(12) Patent Application Publication
(10) Pub. No.: US 2016/0140287 A1
(43) Pub. Date: May 19, 2016

(54) Template Creation Device for Sample Observation Device, and Sample Observation Device

(71) Applicant: HITACHI HIGH-TECHNOLOGIES CORPORATION, Minato-ku, Tokyo (JP)

(72) Inventors: Yuki OJIMA, Tokyo (JP); Shigeki SUKEGAWA, Tokyo (JP); Yuichi ABE, Tokyo (JP); Toshikazu KAWAHARA, Tokyo (JP); Wataru NAGATOMO, Tokyo (JP); Shinji KUBO, Tokyo (JP)

(21) Appl. No.: 14/898,229

(22) PCT Filed: May 19, 2014
(86) PCT No.: PCT/JP2014/063208

§ 371 Date: Dec. 14, 2015

(30) Foreign Application Priority Data
Jun. 25, 2013 (JP) 2013-132829

(51) Int. Cl. G06F 17/50

(52) U.S. Cl. CPC G06F 17/5081

(57) ABSTRACT

A template creation device for a sample observation device for creating a template for image processing using design data includes a storage unit for storing process information in which information concerning a plurality of process processings is defined, and a template creation unit for processing the design data using the process information and creating the template for the image processing.

### TECHNICAL FIELD

The present invention relates to a template creation device for a sample observation device, and to the sample observation device.

### BACKGROUND ART

In the case of size measurement of a pattern of a semiconductor device using a sample observation device such as a length-measuring Scanning Electron Microscope (SEM), when automatic measurement is carried out, a pattern is detected by image processing using a template for an image acquired by the device, thereby specifying a measurement location.

There is a method to register an image of an actual measurement pattern such as an SEM image as a template for detecting a pattern. According to the method to register the SEM image, it is necessary to once acquire the image by the sample observation device, and it is necessary to use a wafer which is a subject to be measured and the sample observation device which acquires an image.

It is also possible to create a template for image processing using design data such as a CAD instead of the SEM image. Design data such as the CAD is processed, this is registered as a template, an image is acquired by the sample observation device, and a pattern is detected. When the pattern is detected, the pattern registered as the template is deformed and processed, and this pattern is compared with an image of a pattern to be measured and according to this, the pattern can be detected. By using design data as a template, it is possible to create a template without using a wafer.

PTL 1 discloses a technique for creating, from design data, a template image for detecting a pattern. It is described in PTL 1 that by deforming a pattern using information of a pattern size, a rounding processing amount of a corner portion and an edge size, it is possible to bring a template image for detecting a pattern close to an actual pattern shape.

### CITATION LIST

### Patent Literatures

PTL 1: JP 2011-154223 A

PTL 2: WO 2007-094439 A

### SUMMARY OF INVENTION

### Technical Problem

According to the technique of PTL 1, if a resist pattern and an etching pattern of process processings are simple, it is possible to create a template only by deforming a size of the pattern, and shapes of a corner and an edge of the pattern.

However, since semiconductor devices are miniaturized and processes become complicated, even when a single layer is processed as in PTL 1, it becomes necessary to process the layer using a plurality of process processings. For example, there are (1) a pattern from which its end is removed by a plurality of times of etching processings, (2) a pattern on which a plurality times of spacers are accumulated, (3) a pattern created by multiple patterning such as Self-Aligned Double Patterning (SADP) and Self-Aligned Quadruple Patterning (SAQP) of a spacer process, and (4) a pattern of block polymer (BCP) in a guide pattern of Directed-self assembly (DSA). Especially in the case of a pattern such as a spacer and BCP which is added by carrying out a plurality of process processings, design data concerning these patterns does not exist in some cases, and the conventional technique of PTL 1 cannot handle this problem.

Concerning a pattern in which a plurality of process processings are executed, the present invention provides a technique for appropriately creating an image processing template by executing image processing while taking these process processings into account.

### Solution to Problem

To solve the above problem, configurations described in Claims are employed for example. The present application includes a plurality of means for solving the problem. As one example, provided is a template creation device for a sample observation device for creating a template for image processing using design data, the template creation device including: a storage unit for storing process information in which information concerning a plurality of process processings is defined; and a template creation unit for processing the design data using the process information and creating the template for the image processing.

Further, as another example, provided is a sample observation device including the template creation device. The sample observation device includes a pattern detection unit for executing an image recognition processing for an image acquired by the sample observation device using the template. The pattern detection unit may execute at least one of processings which include deformation, addition and removal of a pattern with respect to the template acquired from the template creation device.

### Advantageous Effects of Invention

According to the present invention, it is possible to create an appropriate template with respect to a pattern in which a plurality of process processings are executed. According to this, it is possible to stably detect a pattern in which a plurality of process processings are executed. Further features related to the present invention will become apparent from the following description and attached drawings of this description. Objects, configurations and effects other than those described above will be apparent from the following description of embodiments.

### BRIEF DESCRIPTION OF DRAWINGS

FIG. 1A is a diagram illustrating a configuration of a template creation device for a sample observation device according to the present invention.

FIG. 1B is a flowchart for describing creation of an image processing template and describing a using method of the template.

FIG. 2 is a registration flowchart of design data and process information.

FIG. 3 illustrates one example of a registration screen of design data.

FIG. 4 illustrates a display example of design data in the template creation device.

FIG. 5A illustrates one example of process information.

FIG. 5B illustrates one example of the process information.

FIG. 5C illustrates one example of the process information.

FIG. 5D illustrates one example of the process information.

FIG. 6A illustrates one example of parameter information.

FIG. 6B illustrates one example of the parameter information.

FIG. 6C illustrates one example of the parameter information.

FIG. 6D illustrates one example of the parameter information.

FIG. 7A illustrates one example of the parameter information and illustrates an example in which one parameter is set.

FIG. 7B illustrates one example of the parameter information and illustrates an example in which a plurality of parameters are set.

FIG. 7C illustrates one example of the parameter information and illustrates an example in which a parameter is set while taking a variation value into account.

FIG. 7D illustrates one example of the parameter information and illustrates an example in which a parameter is set in an automatic deformation mode.

FIG. 8A illustrates a registration example of design data when etching processing is carried out twice.

FIG. 8B illustrates a registration example of process information when etching processing is carried out twice.

FIG. 8C illustrates a registration example of parameter information when etching processing is carried out twice.

FIG. 9 illustrates one example of template creation processing when etching processing is carried out twice.

FIG. 10 illustrates another example of template creation processing when etching processing is carried out twice.

FIG. 11A illustrates a registration example of design data when a spacer is added twice.

FIG. 11B illustrates a registration example of process information when a spacer is added twice.

FIG. 11C illustrates a registration example of parameter information when a spacer is added twice.

FIG. 12 illustrates one example of template creation processing when a spacer is added twice.

FIG. 13A illustrates a registration example of design data in the case of SAQP.

FIG. 13B illustrates a registration example of process information in the case of SAQP.

FIG. 13C illustrates a registration example of parameter information in the case of SAQP.

FIG. 14 illustrates one example of template creation processing in the case of SAQP.

FIG. 15A illustrates a registration example of design data in the case of DSA.

FIG. 15B illustrates a registration example of process information in the case of DSA.

FIG. 15C illustrates a registration example of parameter information in the case of DSA.

FIG. 16 illustrates one example of template creation processing in the case of DSA.

FIG. 17 illustrates one example for executing processing with respect to a plurality of layers to create a template.

FIG. 18 illustrates another example of template creation processing when etching processing is carried out twice.

### DESCRIPTION OF EMBODIMENTS

Embodiments of the present invention will be described below with reference to the accompanying drawings. Although the accompanying drawings show specific embodiments which are in line with a principle of the present invention, the drawings are illustrated for making it easy to understand the invention, and the drawings should not be used for interpreting the invention in a limited way.

As a sample observation device, there is a charged particle beam device which scans charged particle beam (electron for example) on a sample surface and which uses secondary generated electron. The embodiment described below can be applied to the charged particle beam device. As a representative example of the charged particle beam device, there is an electron microscope (SEM: Scanning Electron Microscope).

### First Embodiment

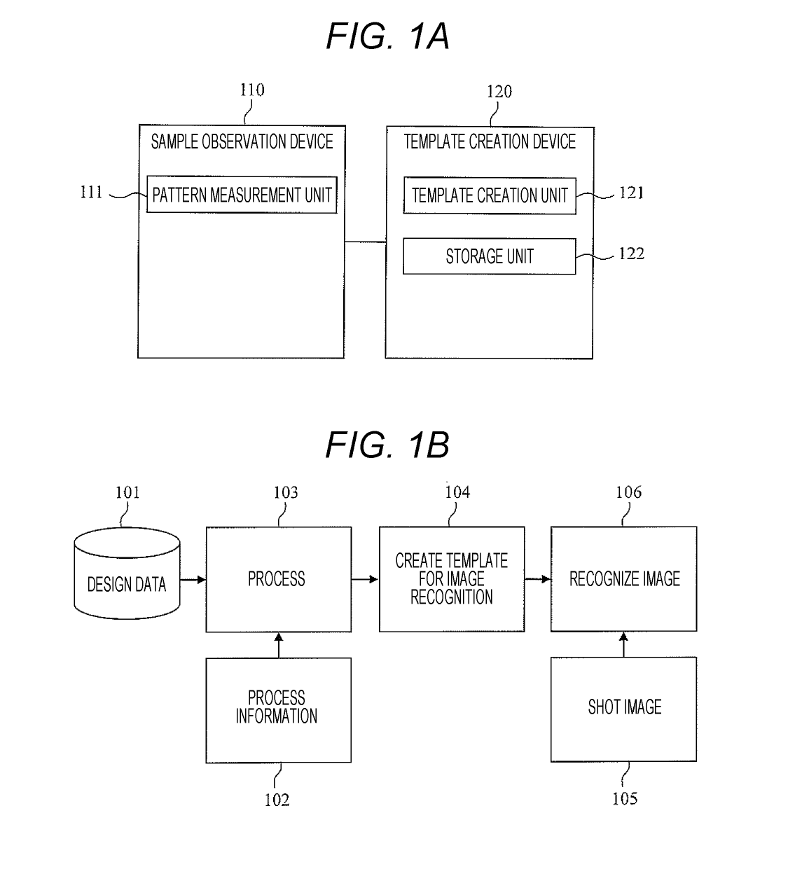

FIG. 1A is a diagram illustrating a configuration of a template creation device for a sample observation device. The template creation device 120 of a first embodiment is connected to the sample observation device 110. The sample observation device 110 includes a pattern measurement unit 111. The template creation device 120 includes a template creation unit 121 and a storage unit 122.

The template creation device 120 can be realized as an image processing device using a general-purpose computer. The template creation unit 121 creates a template from design data and process information. The pattern measurement unit 111 detects and measures a pattern by executing image recognition processing for an image acquired by the sample observation device using the created template. The storage unit 122 is for storing design data, process information and a template which will be described below.

The template creation device 120 includes a processing unit, an auxiliary storage device, a main storage device and an input/output device. For example, the processing unit is composed of a processor (also called arithmetic unit) such as a Central Processing Unit (CPU). For example, the auxiliary storage device is a hard disk, and the main storage device is a memory. The input/output device is a keyboard, a pointing device (such as mouse) and a display.

The template creation unit 121 of the template creation device 120 and the pattern measurement unit 111 of the sample observation device 110 may be realized as functions of programs executed on a computer. That is, processing described later may be stored in the memory as program codes, and may be realized when the CPU executes the program codes. The template creation unit 121 and the pattern measurement unit 111 may be realized by hardware by designing using an integrated circuit. The storage unit 122 is realized by the above-described auxiliary storage device or main storage device.

Although the sample observation device 110 and the template creation device 120 are separate devices in FIG. 1A, the sample observation device 110 may be provided with the function of the template creation device 120.

A creation method of a template using the design data and the process information and a using method of the template will be described in the embodiment. FIG. 1B is a flowchart for describing the creation method of the template for processing an image, and the using method of the template.

Design data 101 such as a CAD is stored in the storage unit 122. As the design data 101, a GDSII format and an OASIS format composed of information of apexes of a diagram are general. The template creation device 120 can display the design data 101 on a screen of the input/output device by displaying a diagram by connecting apexes in the design data to each other, or by displaying a diagram by painting over the diagram with arbitrary color. Design data 101 used for creating a template may be data of other than GDSII format or OASIS format.

Process information 102 is also stored in the storage unit 122. Here, contents of a plurality of process processings executed when a pattern is created are defined in the “process information”. The process information 102 is not included in the design data 101, and contents of the process information 102 will be described later.

The template creation unit 121 acquires the design data 101 and the process information 102. The template creation unit 121 processes the design data 101 using the process information 102 (103). The template creation unit 121 registers the processed design data in the storage unit 122 as a template (104).

The sample observation device 110 acquires shot image 105 of a pattern on a sample. The pattern measurement unit 111 executes image recognition processing for the shot image 105 acquired by the sample observation device 110, thereby detecting and measuring the pattern (106).

In this embodiment, the process information 102 in which contents of a plurality of process processings are defined are registered, the design data 101 is processed using the process information 102, and it is possible to create a template which corresponds to a process.

Although a template is registered by previously executing all of processings in the above-described example, the present invention is not limited to this example. For example, information which is required for detecting a pattern may be registered as a template, and a template may be created by executing all of processings in preprocessing of the pattern detection and measurement (106). For example, the pattern measurement unit 111 of the sample observation device 110 may execute, as the preprocessing, at least one of processes, i.e., deformation of a pattern, addition of a pattern and removal of a pattern, and may create a final template. The creation processing of a template may not be executed by the template creation device 120, and the sample observation device 110 may execute a portion of the creation processing of the template.

A parameter used for creating a template may automatically be extracted from the shot image 105 of the sample observation device 110, and the parameter may be registered in the storage unit 122 as a database. The template creation device 120 may execute creation processing of a template using information of this database. The template may be used in combination with position information of a length measurement point.

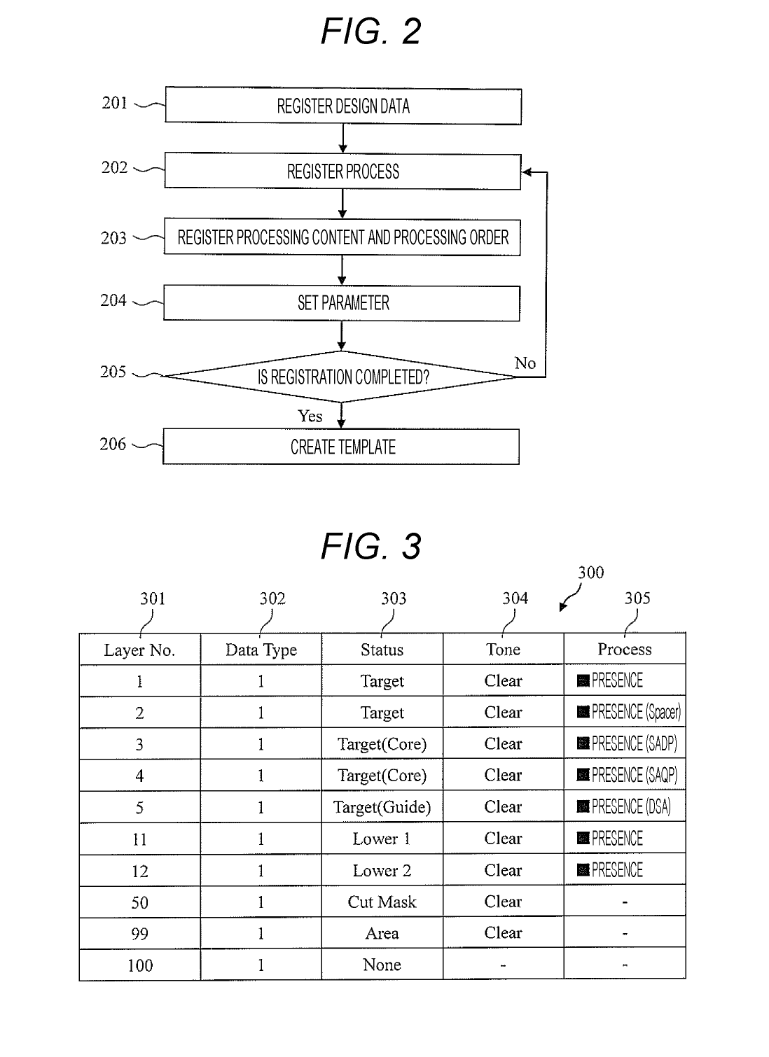

FIG. 2 is a registration flowchart of the design data 101 and the process information 102. Registration of the following various kinds of information may be input through an input device of the template creation device 120 or may be input by a file in a predetermined form.

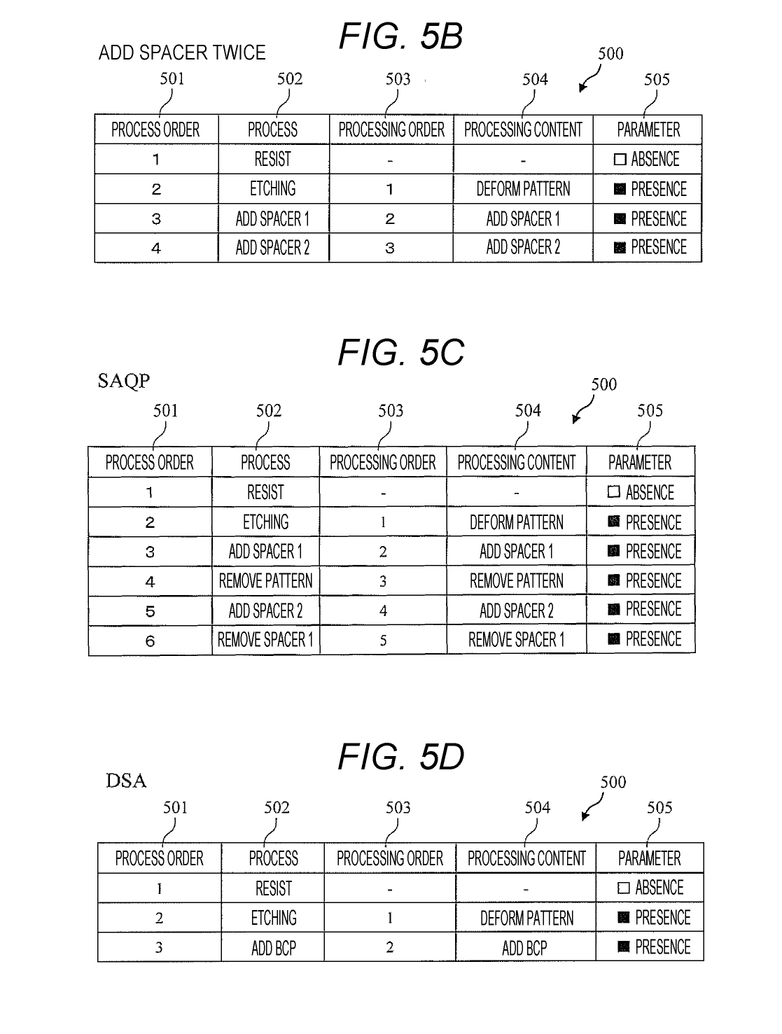

First, design data 101 is registered in the storage unit 122 of the template creation device 120 (201). Thereafter, a processing (corresponds to process 502 in FIGS. 5A to 5D) is registered in the storage unit 122 of the template creation device 120 (202). Next, processing contents and processing order corresponding to the registered process are registered (203). Then, a parameter concerning the processing contents is set (204). Next, if input of all of processes is not completed, the procedure returns to step 202 (NO in 205). If input of all of processes is completed (Yes in 205), creation processing of a template is executed (206).

By the above-described registration of the process information 102, processes are registered in accordance with processing order. Therefore, it is possible to process the design data 101 in the designated order. If the processing order of the design data 101 is different, a created template has a different shape. Therefore, by designating the processing order of processes, it is possible to appropriately deform a template.

If there are processing contents and processing order corresponding to a process, and information of a parameter, it is possible to create a template and registration (202) of a process is not indispensable. Further, it is also possible to collectively register by selecting process information, processing contents, processing order and a parameter from a previously formed database. It is also possible to eliminate process information which is unnecessary for creating a template and to register only necessary information as the process information 102.

FIG. 3 shows one example of a registration screen of design data. The design data 101 is stored in the storage unit 122 of the template creation device 120. It is not absolutely necessary that the design data 101 is stored in the template creation device 120, and the design data 101 may be acquired from another device through a network.

In the following description, information of this embodiment will be described using a “table” structure, but the information may not absolutely be expressed in a data structure by a table, and the information may be expressed a data structure such as a list and a queue or other structure. Hence, to show that information does not depend on the data structure, “table”, “list” and “queue” are simply called “information” in some cases.

As shown in FIG. 3, design data 300 includes “Layer No.” (301), “Data Type” (302), “Status” (303), “Tone” (304) and “Process” (305) as configuration items. Design data 300 sets such as a CAD are classified in accordance with “Layer No.” (301) and “Data Type” (302), and “Status” (303) is designated for “Layer No.” (301) and “Data Type” (302) which are used for measurement.

For example, when Layer No.=1 is a water most-surface pattern, an upper layer (Target) is designated for “Status” (303) of Layer No.=1. If Layer No.=11 is a layer located below the upper layer, “Status” (303) of Layer No.=11 is designated as the lower layer (Lower). Concerning the lower layer (Lower), it is possible to designate a plurality of layers. In this case, it is possible to set “Lower1”, “Lower2”, . . . as “Status” (303), and a layer located below Lower1 can be set as “Lower2”.

It is also possible to designate concavo-convex information with respect to a pattern of design data. When a portion where design data is closed is left, (convex portion) is set as “Clear” in “Tone” (304), and when a portion where design data is closed is pulled, (concave portion) is set in “Tone” (304) as “Dark”. Concerning “Layer No.” (301) which is not used for creating a template, “None” is set in “Status” (303).

In the registration of design data, a portion where a pattern is removed by etching can be set in “Status” (303) as “Cut Mask”, and a portion to be processed can be set in “Status” (303) as “Area”.

In the case of “Cut Mask”, a region which is removed by setting of “Tone” (304) can be inverted. For example, if setting of “Tone” (304) is set to “Clear”, it is possible to remove a portion where design data is closed, and if the setting of “Tone” (304) is set to “Dark”, a portion other than the portion where the design data is closed can be removed.

In this embodiment, an item of “Process” (305) is added to the design data 300 shown in FIG. 3. The item of “Process” (305) is set to a status of “presence”, and it is possible to designate a layer (“Layer No.”, “Data Type”, a plurality of layers can be selected) where process information 102 is registered. It is possible to register the process information 102 in a separate screen. Details of the process information 102 will be described later. Concerning contents and parameters of the process processings, the same parameter may be used for all of measuring points, or a parameter may be changed in accordance with a measurement point, a pattern and a region, and a plurality of conditions may be registered.

Different process information 102 can be registered for the upper layer (Target) and the lower layer (Lower). In this case, the upper layer (Target) and the lower layer (Lower) are separately processed, and information of the upper layer and the lower layer can be registered as templates. The processing is basically carried out in the order from the lower layer to the upper layer, but the processing can be carried out in accordance with registration status (such as processing order) of process processings.

Processing (deformation processing) of an upper layer pattern may be changed in accordance with a shape of a lower layer pattern. For example, when an upper layer pattern and a lower layer pattern are superposed on each other, a deformation parameter of the upper layer pattern may be changed for the superposed portion.

In the case of SADP and SAQP of a spacer process, a core pattern is removed after a spacer is added to a pattern of a core of the upper layer (Target). Therefore, “Status” (303) of the core layer may be set as “Target (Core)”, and may be distinguished. Since a process of DSA is formed by adding a BCP pattern into a guide pattern of the upper layer (Target), “Status” (303) of the guide pattern may be set as “Target (Guide)” and may be distinguished. Since contents of a process are registered in the process information 102, “Status” (303) may simply be registered as “Target” without using “Target (Core)” and “Target (Guide)”.

When “Target (Core)” is selected, setting of “Process” (305) may automatically be selected from the spacer process such as SADP and SAQP, and when “Target (Guide)” is selected, setting of “Process” (305) may automatically be selected from DSA process. According to this, registration of the process information 102 becomes easy.

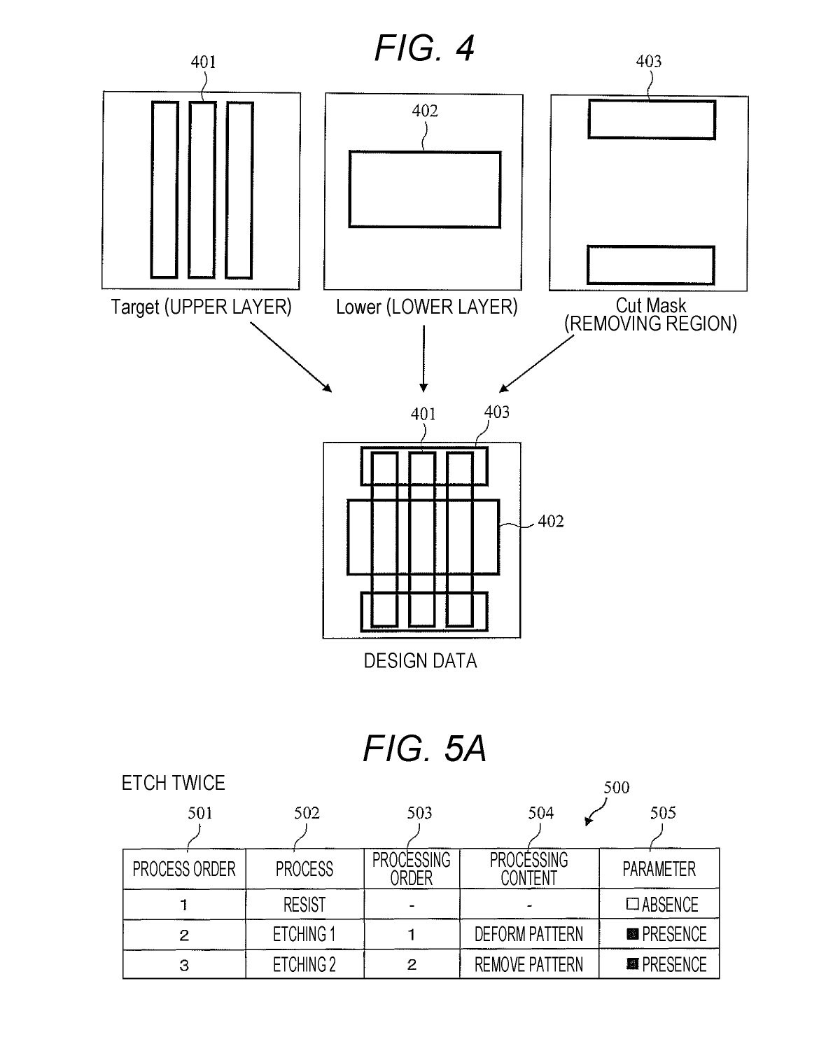

FIG. 4 shows a display example of design data in the template creation device 120. In this example, design data 401 of the upper layer (Target), design data 402 of the lower layer (Lower) and design data 403 of a removing region (Cut Mask) are set and displayed. If the processing order of the design data becomes different, a template of the image processing becomes different. Hence, the processing order of the process processings is registered as the process information 102, and the processing order of the design data is set.

FIGS. 5A to 5D show a registration example of process information. The process information shown in FIGS. 5A to 5D is data which is set when the item of “Process” (305) of the design data shown in FIG. 3 is set to “presence”. Process information in FIGS. 5A to 5D is registered in association with “Layer No.” (301) of design data 300 shown in FIG. 3.

The process information in FIGS. 5A to 5D may collectively be displayed on the display of the template creation device 120 and registered, or the process information may individually be displayed and set. The registered process information is stored in the storage unit 122 of the template creation device 120.

FIG. 5A shows one example of process information when “etching is carried out twice”. FIG. 5B shows one example of process information when “spacer is added twice”. FIG. 5C shows one example of process information in the case of SAQP. FIG. 5D shows one example of process information in the case of DSA.

As shown in FIGS. 5A to 5D, process information 500 includes, as configuration items, processing order 501, a process 502, processing order 503, processing contents 504 and a parameter 505. For example, the process information 500 includes, as processing contents 504, at least one of deformation of a pattern, addition of a pattern and deletion of a pattern.

In registration of the process information 500, the processing order 501 and the process 502 are registered, and information such as the processing order 503, the processing contents 504 and the parameter 505 which are necessary for creating a template is set. The template is created by processing in accordance with the processing order 503, the processing contents 504 and the parameter 505. According to such a configuration, it is possible to process design data while taking the order of processes into account. Further, it is possible to set a parameter for each of processes, and to carry out different processing for each of processes.

Although the process 502 and the processing contents 504 are registered in association with each other in this embodiment, it is also possible to set a plurality of only the processing order 503, the processing contents 504 and the parameter 505 without registering the processing order 501 and the process 502. For example, the processing order 503 and the processing contents 504 may be set and information concerning a process may be perceived by means of comments with respect to the processing contents 504.

In the case of an etching pattern, it is also possible to deform a pattern directly into an etching pattern without deforming design data of a resist into a resist pattern. For example, when a template corresponding to a pattern after etching processing is created using design data of a resist pattern, it is also possible to carryout deformation processing such that a shape after etching processing is obtained by one deformation processing while eliminating deformation processing of a resist pattern from design data of the resist pattern. In the example shown in FIG. 5A, setting of the deformation processing is for carrying out deformation processing by etching processing without carrying out deformation processing of a resist pattern, but the setting may be registered as “resist and etching” processing.

When design data having Optical Proximity Correction (OPC) is used, it is also possible to carry out deformation processing of a shape of a resist pattern by simulation as deformation processing of a resist pattern and then, deformation processing can be carried out by etching.

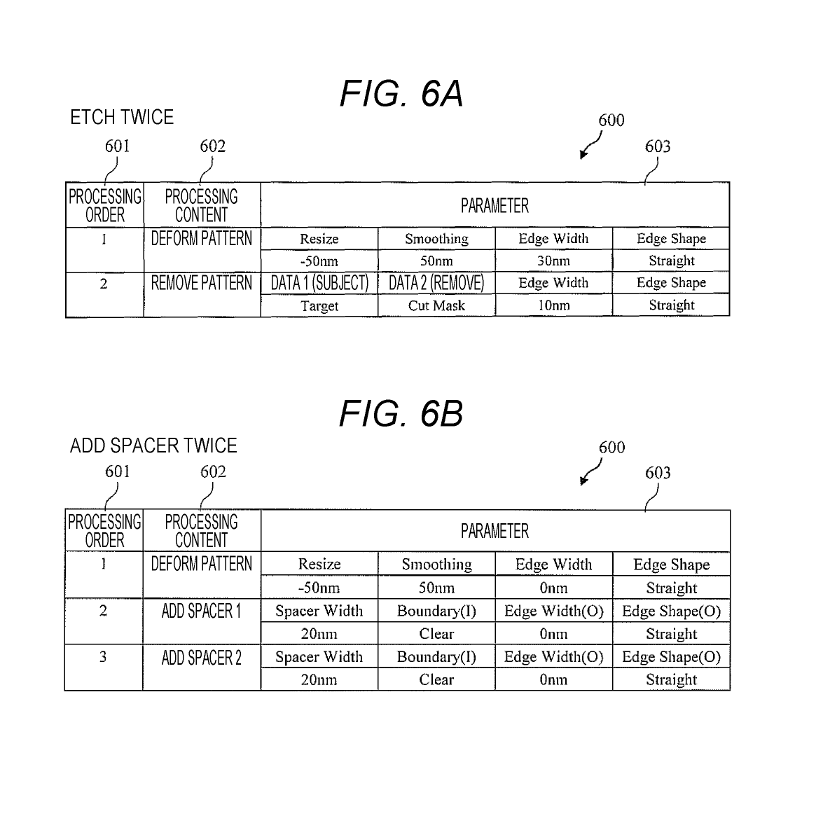

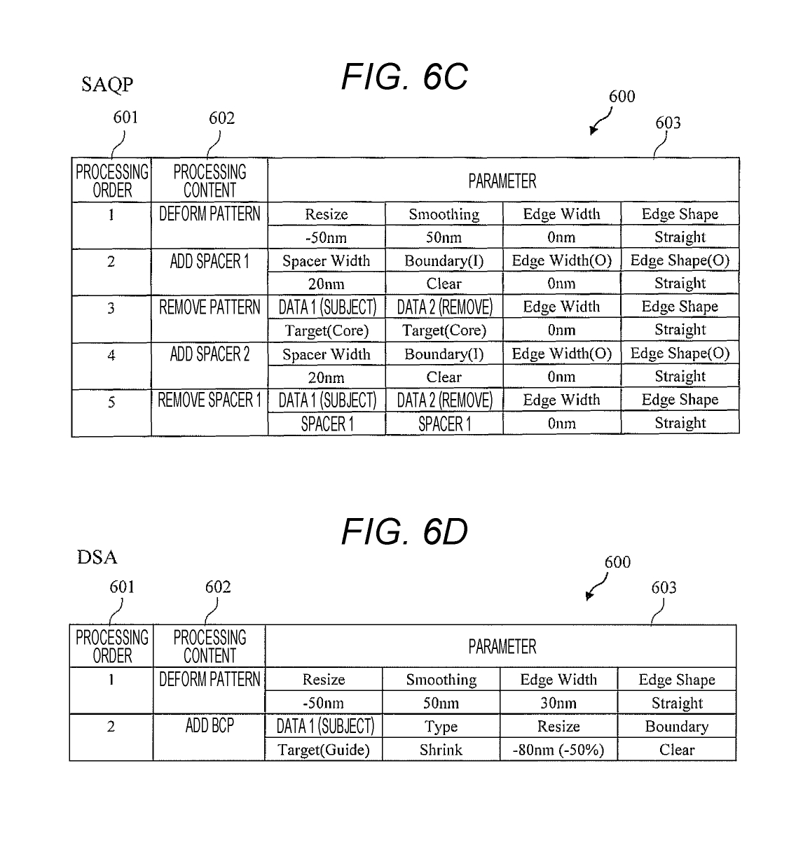

FIGS. 6A to 6D show an example in which parameter information is registered with respect to processes and processing contents which are set in FIGS. 5A to 5D. Parameter information in FIGS. 6A to 6D is data which is set when items in the parameter 505 of the process information 500 in FIGS. 5A to 5D are set to “presence”. The parameter information in FIGS. 6A to 6D is registered in association with the process 502 in FIGS. 5A to 5D.

The parameter information in FIGS. 6A to 6D may collectively be displayed on a display of the template creation device 120 and registered, or may individually be displayed and set. Registered parameter information is stored in the storage unit 122 of the template creation device 120.

FIG. 6A shows one example of parameter information when “etching is carried out twice”. FIG. 6B shows one example of parameter information when “spacer is added twice”. FIG. 6C shows one example of parameter information in the case of SAQP. FIG. 6D shows one example of parameter information in the case of DSA.

As shown in FIGS. 6A to 6D, parameter information 600 includes processing orders 601, processing contents 602 and parameters 603 as configuration items. Therefore, it is possible to set different parameters in accordance with processing contents such as deformation, removal and addition of a pattern. That is, it is possible to set a parameter in accordance with processing contents of a process. Since a template is created in accordance with an input value of a parameter, it is possible to create a template having small alienation from a pattern shape. The processing contents 602 and the parameter 603 can correspond in an expansion manner in accordance with a process and design data.

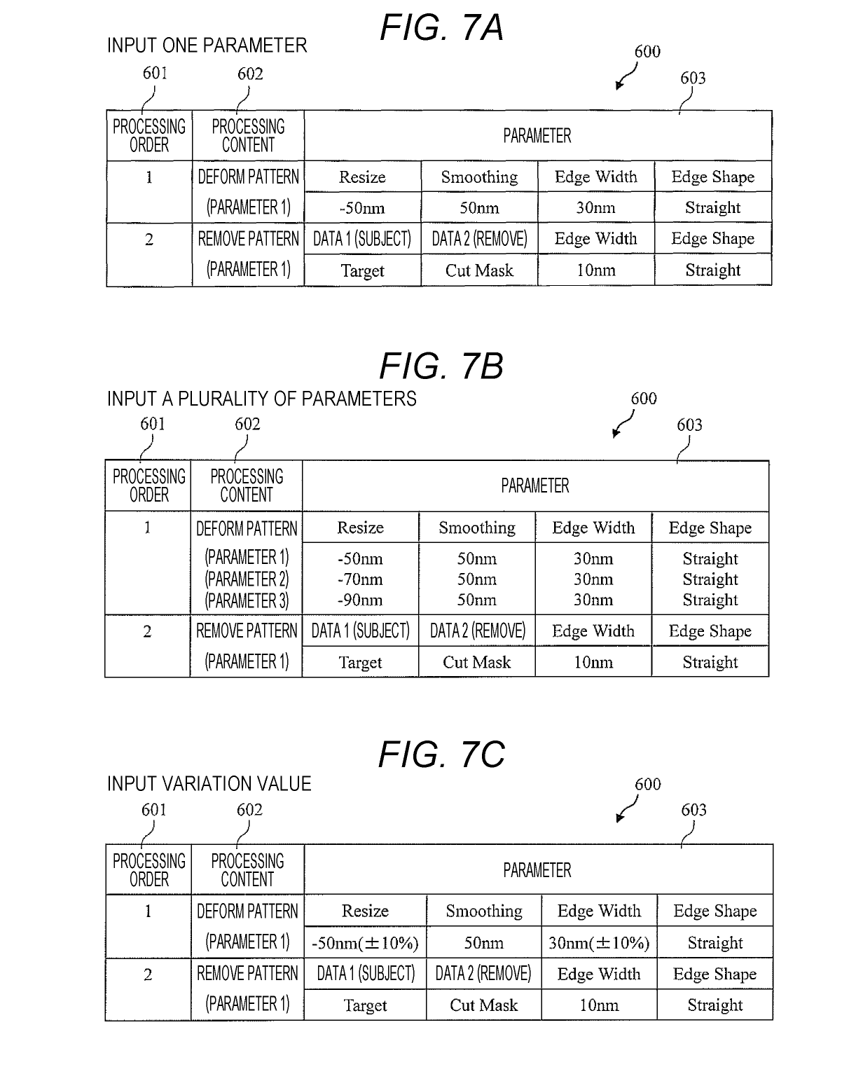

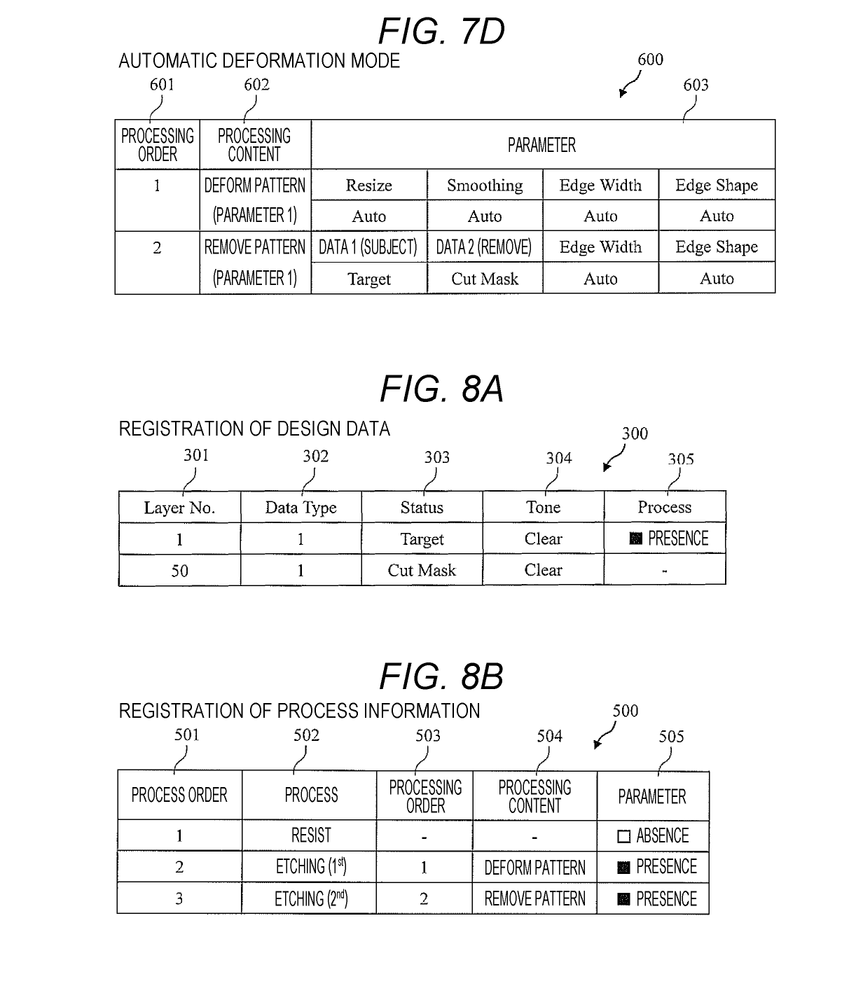

FIGS. 7A to 7D show another example in which parameter information is registered with respect to a process and processing contents which are set in FIG. 5A. When sizes and shapes of patterns are varied, it is also possible to set a plurality of values of parameters as shown in FIG. 7B or to create a template by automatically changing the values as shown in FIG. 7D. In the case of automatic changing, a parameter may be changed within a predetermined numeric value width. Further, as shown in FIG. 7C, a variation value (e.g., ±10% or ±10 nm with respect to size of design data or size of target) such as a shape, a size and a position of a pattern caused by influence of a process may be set, and a plurality of templates may be formed or image processing may be carried out while taking the variation into account.

The template creation device 120 may automatically extract parameter information such as deformation processing from an image which is acquired by the sample observation device 110 and from the design data 101 which is used for a template. The template creation device 120 may previously store the automatically extracted parameter information in the storage unit 122 as a database. According to this, when a template with respect to a similar pattern is to be created, it becomes easy to set a parameter.

Since it is troublesome to register a plurality of process information sets one by one, some kinds of process processings may previously be formed as a database so that it becomes easy to set the process information 102 (processing contents of process and parameter corresponding to the processing contents). For example, process information sets and a combination of these process information sets such as (1) (etching is carried out twice), (2) (spacer is added twice), (3) SADP, (4) SAQP, (5) DSA (shrinking process) and (6) DSA (segmentalizing process) may be stored in the storage unit 122 of the template creation device 120 in the form of a database. An operator may appropriately select a parameter from the database and may register the parameter.

Concerning a process such as SADP and SAQP, processing contents may be patterned, and information concerning a size, an interval and a shape of a pattern which is formed finally may be set in processing contents and a parameter.

As the first embodiment, an example in which a template of a pattern is created will be described below, and this pattern is created by carrying out etching processing twice. This embodiment shows an example in which when a pattern of a resist is subjected to etching processing, an etching pattern is formed by first etching processing and then, an end of the pattern is removed by a second etching processing.

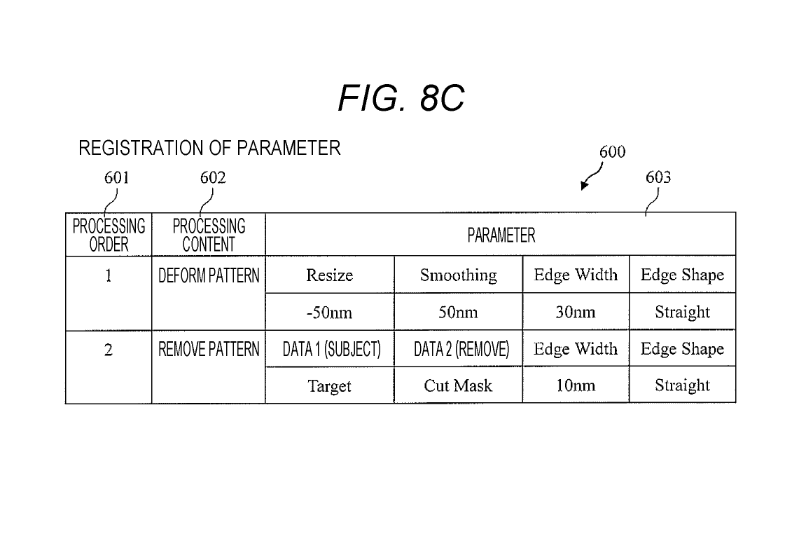

FIG. 8A shows a registration example of the design data 300 when the etching processing is carried out twice. FIG. 8B shows a registration example of the process information 500 when the etching processing is carried out twice. The process information 500 is set such that “(first) etching” and “(second) etching” are executed in this order with respect to the design data 300.

FIG. 8C shows a registration example of the parameter information 600 when the etching processing is carried out twice. In the parameter 603 of “pattern deformation”, an amount of size deformation is set in “Resize”, a rounding amount of a corner is set in “Smoothing”, an edge width value is set in “Edge Width”, and an edge shape is set in “Edge Shape” . In the parameter 603 of “pattern removal”, data which is a subject is set in “data 1 (subject)”, data which is used for removal is set in “data 2 (removal)”, an edge width value is set in “Edge Width”, and an edge shape is set in “Edge Shape”.

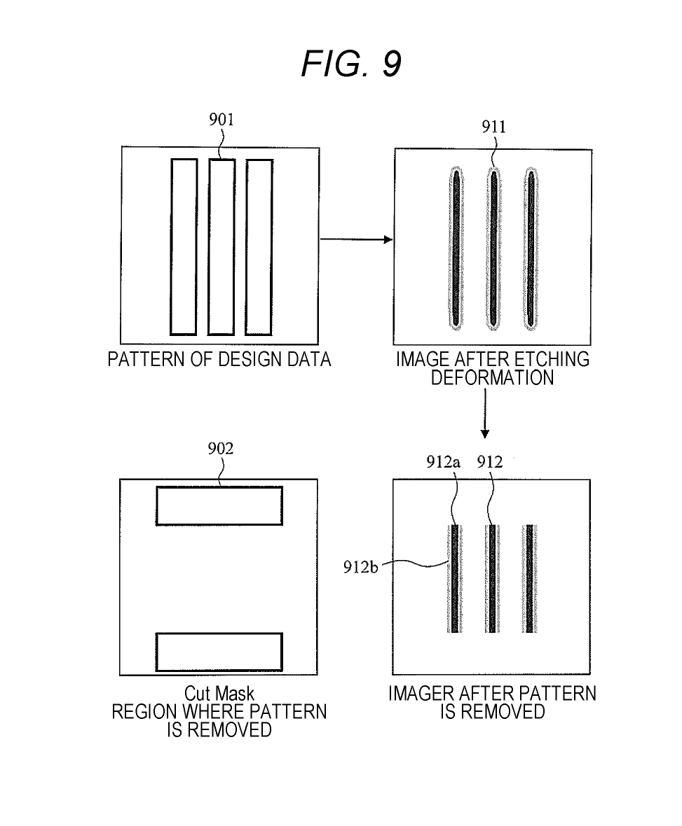

FIG. 9 shows a forming example of a template when the etching processing is carried out twice. A main body for the following processings is the template creation unit 121 of the template creation device 120. The template creation unit 121 executes the deformation processing with respect to design data 901 of a resist pattern, and forms a pattern 911 having a shape which is created by first etching processing. Thereafter, the template creation unit 121 removes a portion of a Cut Mask (902) by the second etching processing, and forms an image of a pattern 912 after second etching.

Deformation processing concerning the first etching processing is executed by deforming a size, a corner and an edge by the same technique as that of PTL 1. In this embodiment, in the parameter 603 as shown in FIG. 8C, a size deformation amount is set in “Resize”, a rounding amount of a corner is set in “Smoothing”, an edge width value is set in “Edge Width”, and an edge shape is set in “Edge Shape”. The template creation unit 121 executes the deformation processing using these parameter information sets.

In this embodiment, with respect to a pattern 911 after deformation carried out by first etching, an image of a pattern 912 from which a pattern of the Cut Mask portion is removed by second etching is formed. Therefore, in the example in FIG. 9, a portion of “Cut Mask (Layer No.=50)” is removed from a pattern of “Target (Layer No.=1)” after the first etching. Here, an edge 912a which is removed by the second etching and is produced can be processed into a shape which is different from an edge 912b after the first etching processing by setting “Edge Width” and “Edge Shape” of a pattern removing parameter. That is, it is possible to process edge shapes in accordance with a plurality of processes.

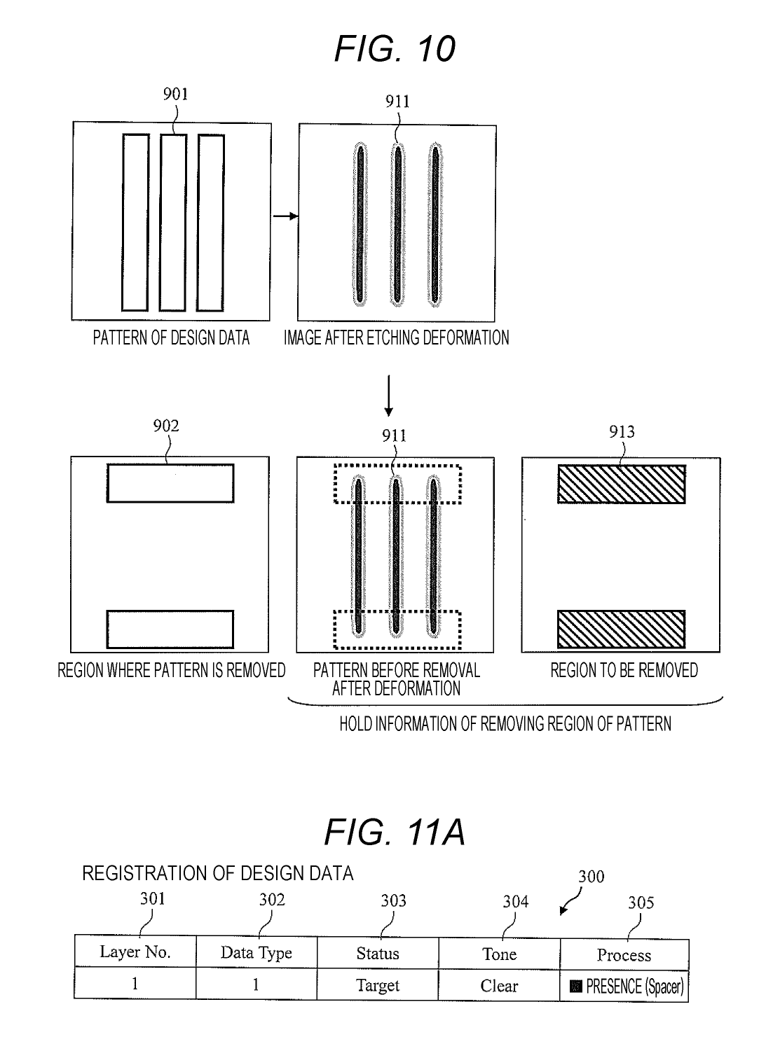

FIG. 10 shows another example of template creation when the etching processing is carried out twice. As shown in FIG. 10, with respect to the pattern 911 which is created by the first etching, a portion thereof which is removed by the second etching may not be removed, and a portion 913 which is removed by the second etching may be held as information. In this case, the pattern measurement unit 111 may mask the portion 913 with respect to the pattern 911, thereby detecting the pattern (image recognition processing). That is, as a template for detecting a pattern, information of a pattern shape 911 after the first etching and information of the portion 913 of “Cut Mask” which is removed by the second etching may be held, and creation of an image for detecting a pattern may be adjusted in accordance with a status of the first etching. According to this, it is possible to appropriately adjust a template immediately before detecting a pattern, and to detect the pattern.

Although it is described above that the pattern measurement unit 111 masks the portion 913 with respect to the pattern 911 immediately before detecting the pattern, the present invention is not limited to this processing. For example, at least of one of information sets, i.e., deformation, addition and removal of a pattern may be sent to the pattern measurement unit 11 as information of a template. In this case, the pattern measurement unit 111 can execute at least of one processing, i.e., deformation, addition and removal of a pattern immediately before detecting a pattern, and can create a final template.

When a pattern is created while intentionally changing a shape thereof, or when change of a size and a shape caused by variation in a process is handled, it is possible to set a parameter of deformation arbitrary (Auto), and to automatically change. In this case, it is possible to automatically change the size when detecting a pattern, and to detect the pattern. Data of a plurality of templates may be created as templates, and a pattern may be detected using a plurality of templates by previously setting a plurality of parameters and by inputting a variation width.

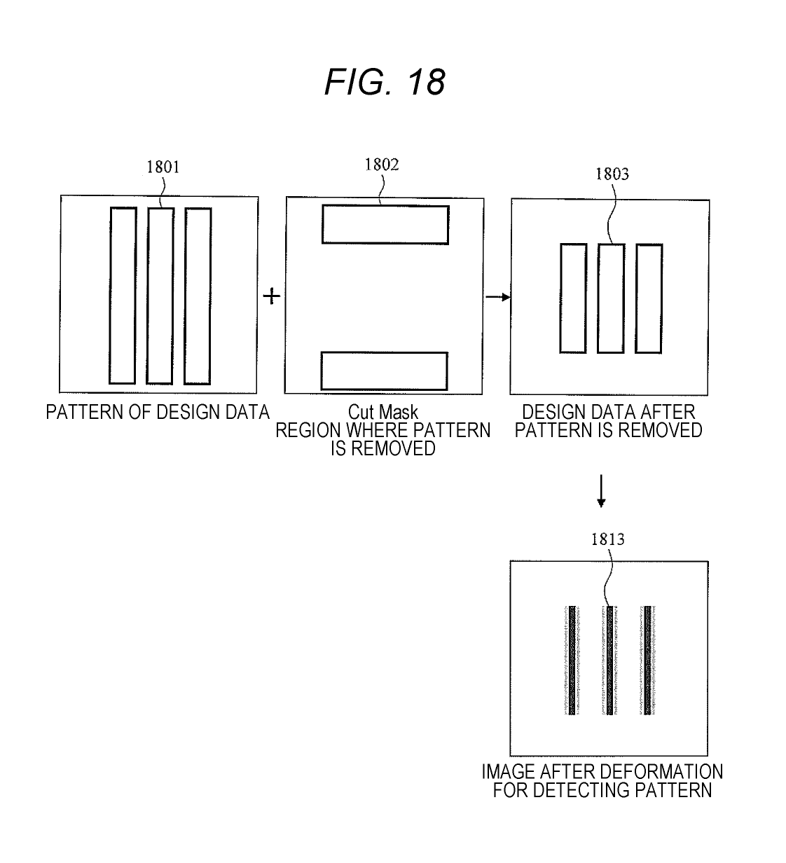

FIG. 18 shows another example of creation of a template when etching processing is carried out twice. As a method other than that described above, design data 1803 formed by removing a pattern 1802 which is removed by second etching from design data 1801 of a resist pattern may be used. In this case, with respect to the design data 1803, a final pattern 1813 can be created by executing deformation processing which corresponds to the first etching processing. Here, it is also possible to change and handle a deforming condition in accordance with a position of a pattern which is etched for the first time and second time. For example, it is possible to set such that a portion which is etched for the second time is not deformed. A parameter of deformation processing may be changed for every portion of the pattern.

When the process information 102 includes information of first etching processing and information of second etching processing in this manner, the template creation unit 121 can execute first processing for carrying out second etching processing (removing processing) after first etching processing (deformation processing), or second processing for carrying out first etching processing (deformation processing) after the second etching processing (removing processing). In this example, the deformation processing and the removing processing are combined with each other, it is possible to change the processing order of processes and create templates also in a combination between the addition processing of patterns and removing processing of the patterns.

From the above-described operations, with respect to a pattern which is subjected to the plurality of process processings (twice etching processings), processings, i.e., addition, removal and deformation of the pattern are appropriately carried out while taking the process into account, and it is possible to create a template for image processing. According to this, it is possible to stably detect a pattern.

### Second Embodiment

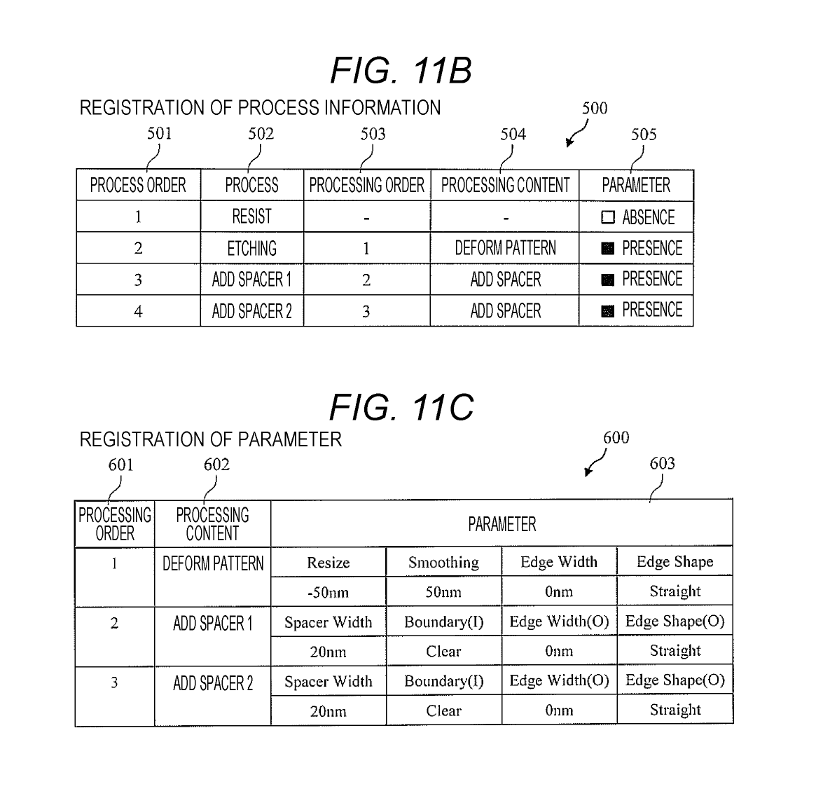

In a second embodiment, an example for creating a template of a pattern on which spacers are accumulated a plurality of times will be described. FIG. 11A shows a registration example of the design data 300 when spacers are accumulated twice. FIG. 11B shows a registration example of the process information 500 when spacers are accumulated twice. The process information 500 is set such that “etching”, “addition of spacer 1” and “addition of spacer 2” are executed for the design data 300 in this order.

FIG. 11C shows a registration example of the parameter information 600 when spacers are accumulated twice. Description of parameter information sets which are already described will be omitted. In the parameter 603 of “addition of spacer 1”, a spacer width is set in “Spacer Width”, information of a boundary between a pattern and a spacer 1 is set in “Boundary (I: Inside)”, an outside edge width is set in “Edge Width (O: Outside), and an outside edge shape of a spacer is set in “Edge Shape (O: Outside)”. The parameter 603 of “addition of spacer 2” is also set in the same manner.

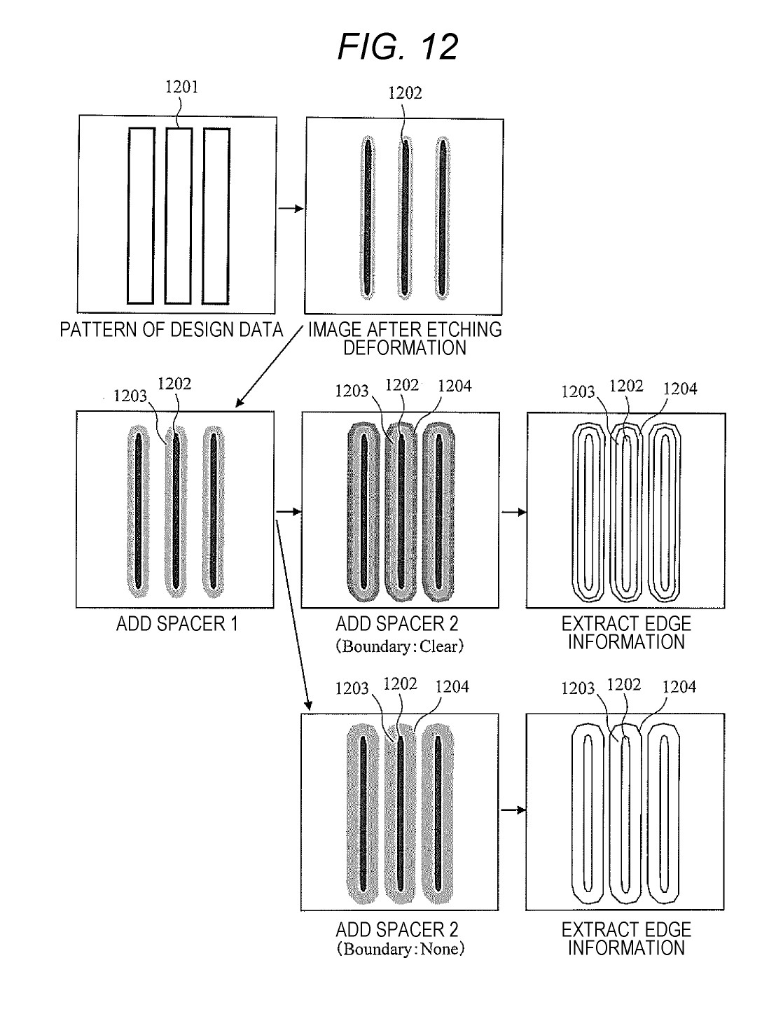

FIG. 12 is a creation example of a template when spacers are accumulated twice. A main body of the following processings is the template creation unit 121 of the template creation device 120. In the creation of a template in FIG. 12, deformation processing is executed for the design data 1201 of a resist pattern, and a pattern 1202 when it is etched is formed. Next, process processings for adding a spacer 1 (1203) to the etched pattern 1202 is executed. Thereafter, an image in which a spacer 2 (1204) is added to outside of the spacer 1 (1203) is formed. Here, if the spacer 1 (1203) and the spacer 2 (1204) are in contact with each other, it is possible to deform also a shape of the spacer 2 (1204) in accordance with a shape of the spacer 1 (1203) by setting the parameter 603. Eventually, an image obtained by extracting an edge of the image to which the spacer 2 is added is formed as a template.

Information of a boundary between the pattern 1202 and the spacer 1 (1203) is set in “Boundary (I)” as the parameter 603 of “addition of spacer 1”, and information of a boundary between the spacer 1 (1203) and the spacer 2 (1204) is set in “Boundary (I)” as the parameter 603 of “addition of spacer 2”.

When an image of a template for detecting a pattern is to be formed, the template creation unit 121 can create a template for detecting a pattern such that a pattern before a spacer is added and a spacer portion are different from each other in contrast (gray level) using the parameter of “Boundary (I)”. According to this, it is possible to detect a pattern while recognizing a boundary between the pattern and the spacer.

For example, when a boundary between the pattern 1202 and the spacer 1 (1203) and a boundary between the spacer 1 (1203) and the spacer 2 (1204) can clearly be distinguished from each other based on a difference in level and a difference in material, “Clear” is set in “Boundary (I)”. As shown in FIG. 12, when “Clear” is set in “Boundary (I)” of “addition of spacer 2”, an image is formed by adding the spacer 2 (1204) having contrast which is different from that of the spacer 1 (1203).

In the case of a pattern in which a boundary cannot be distinguished on the other hand, “None” is set in “Boundary (I)”. As shown in FIG. 12, when “None” is set in “Boundary (I)” of “addition of spacer 2”, an image is formed by adding the spacer 2 (1204) having the same contrast as that of the spacer 1 (1203).

A status of the boundary between the pattern 1202 and the spacer 1 (1203) and a status of the boundary between the spacer 1 (1203) and the spacer 2 (1204) are unclear, “Auto” may be set in “Boundary (I)”. In this case, the template creation unit 121 creates a plurality of templates including a template in which the boundary is distinguished and a template in which the boundary is not distinguished. According to this, it is possible to detect a pattern using a plurality of templates.

Information of a visibility manner such as a boundary (Boundary) between spacer portions and an edge shape (Edge Shape) may previously be stored in the storage unit 122 as a database using a shot image from the sample observation device 110. According to this, it is possible to easily set a parameter.

Other than the method for detecting a pattern using an image of a template, it is also possible to form a signal of an image into a waveform, and to detect a pattern from a shape, a peak position and a width of the signal waveform. In this case, information of the waveform may be stored, as a database, in the storage unit 122 from a previously acquired shot image. By using this database, a pattern can be detected.

According to this embodiment, process information concerning a spacer which does not exist in design data such as a CAD is registered, and a template is created using the process information. By detecting a pattern using this template, it is possible to stably detect even a pattern which cannot handle only by deformation of design data.

### Third Embodiment

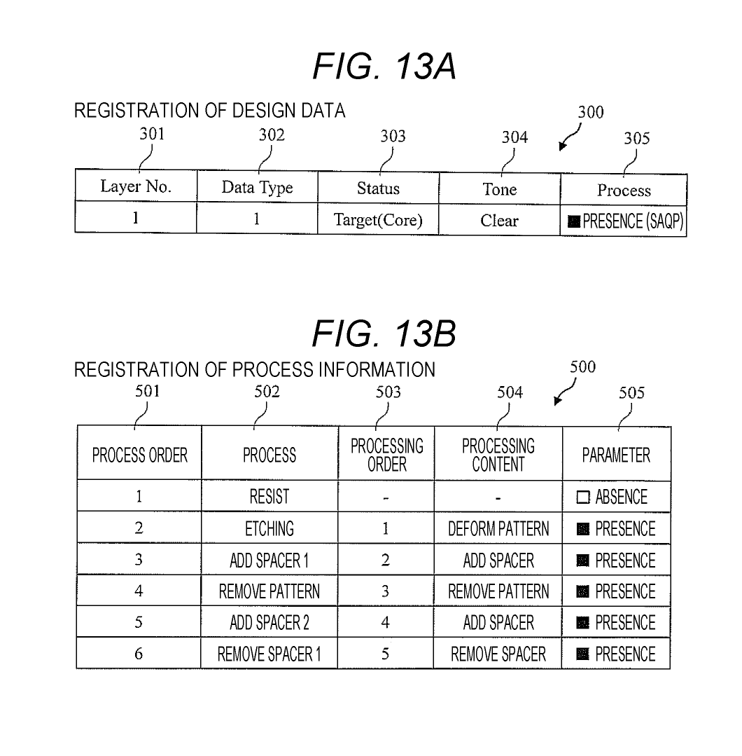

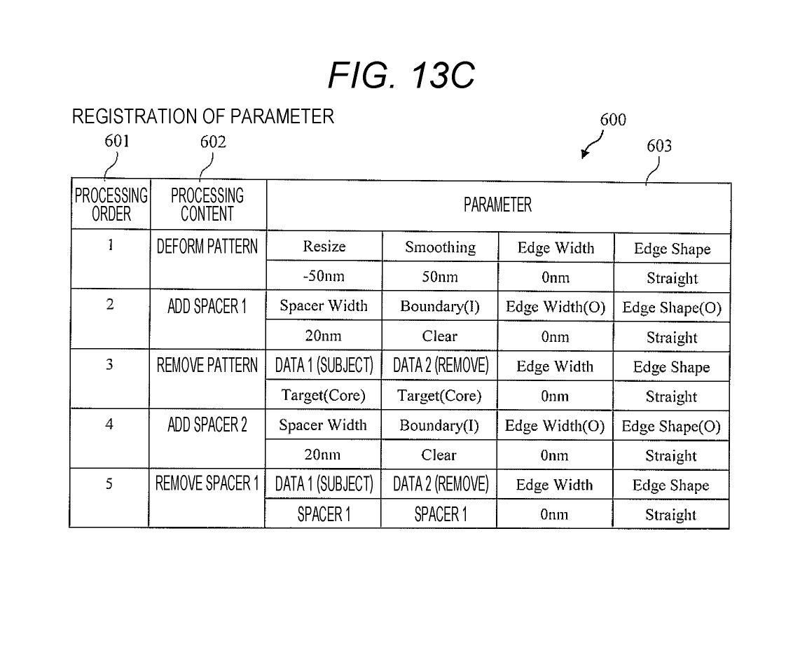

In a third embodiment, an example to create a template of SAQP of a spacer process will be described. FIG. 13A shows a registration example of the design data 300 of SAQP. FIG. 13B shows a registration example of the process information 500 of SAQP. The process information 500 is set such that “etching”, “addition of spacer 1”, “removable of pattern”, “addition of spacer 2”, and “removable of spacer 1” are executed for the design data 300 in this order. FIG. 13C shows a registration example of the parameter information 600 of SAQP. Parameter contents are the same as those of the previous embodiments.

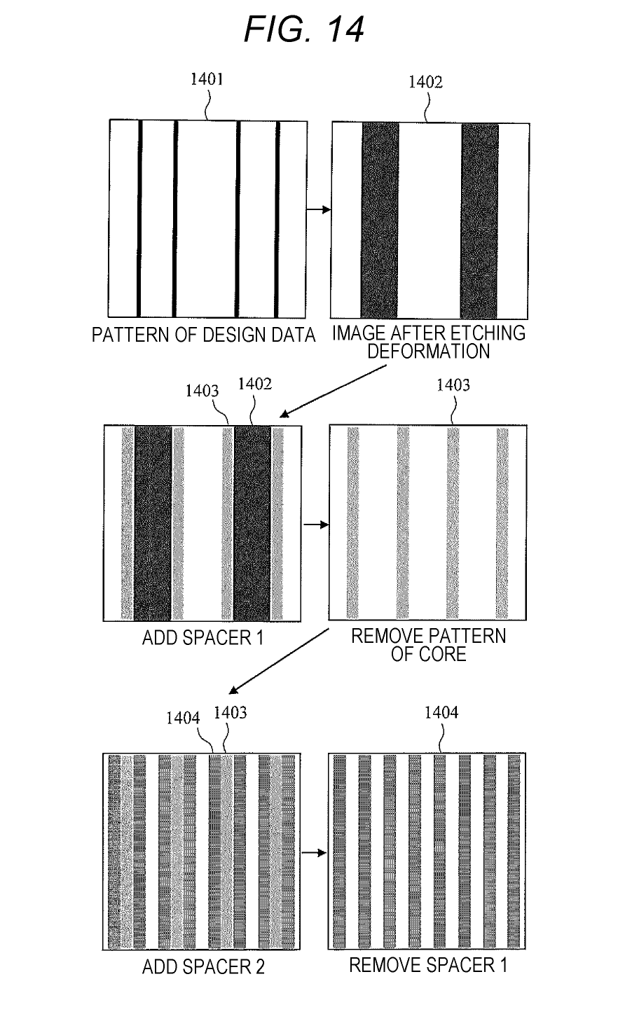

FIG. 14 shows a creation example of a template in the case of SAQP. In this embodiment, a template for detecting a pattern of SAQP is created based on design data 1401 of a pattern of a core of SAQP. A main body of the following processings is the template creation unit 121 of the template creation device 120.

First, a pattern of a core to which a spacer is added is created. The design data 1401 of a resist pattern is deformed, and a pattern 1402 when it is etched is formed. Next, a spacer 1 (1403) is added to the pattern 1402 after etching processing.

Next, the pattern 1402 of the core to which the spacer 1 (1403) is added is removed by the removing processing of a pattern. An edge width and a shape of an edge of a portion where the pattern 1402 of the core and the spacer 1 (1403) are in contact with each other can be set by information of the parameter 603 of “pattern removal”. In the case of SADP, processing for adding the spacer 1 and processing for removing a pattern of the core are the final processings, but in the case of SAQP, the spacer 2 (1404) is added to the spacer 1 (1403) after the pattern 1402 of the core is removed. Information of a parameter of a boundary between the spacer 1 (1403) and the spacer 2 (1404) and information of the edge of the spacer 2 (1404) can be set as a parameter 603 of the parameter information 600.

Eventually, the spacer 1 (1403) is removed, a parameter of only the spacer 2 (1404) is formed, and the formed image is registered as a template. When the spacer 1 (1403) is removed, information of an edge of a width and shape of a portion which is in contact with the spacer 2 (1404) when the spacer 1 (1403) is removed can be set by the parameter 603 of “removal of spacer 1”.

In this embodiment, when a spacer is added to a line pattern, it is possible to distinguish a line-side edge shape and a space-side edge shape from each other as an edge information of the spacer. A difference of the edge shape may previously be stored in the storage unit 122 as a database. By using the database for creating a template, it is possible to use a template to which edge information of the spacer is reflected in pattern detection. As a result, it is possible to stably detect a pattern.

When right and left edge shapes of a spacer are different from each other, since waveforms formed from a signal of an image become asymmetric, it is also effective to detect a pattern using waveform information. Other than the method for detecting a pattern using an image of a template, it is also possible to form a signal of an image into a waveform, and to detect a pattern from a shape, a peak position and a width of the signal waveform.

Concerning registration of a process and processing contents, a pattern of a core becomes a reference in SADP and SAQP. Therefore, it is also possible to handle using a method to register a pitch width, a line width, a space width and edge information of a finally finished pattern in accordance with a process without inputting a size of a pattern which is produced in an intermediate processing.

According to this embodiment, process information concerning a pattern of a core and a spacer portion which does not exist in design data such as a CAD is registered, and a template is created using the process information. According to this, it is possible to create templates for SADP and SAQP.

### Fourth Embodiment

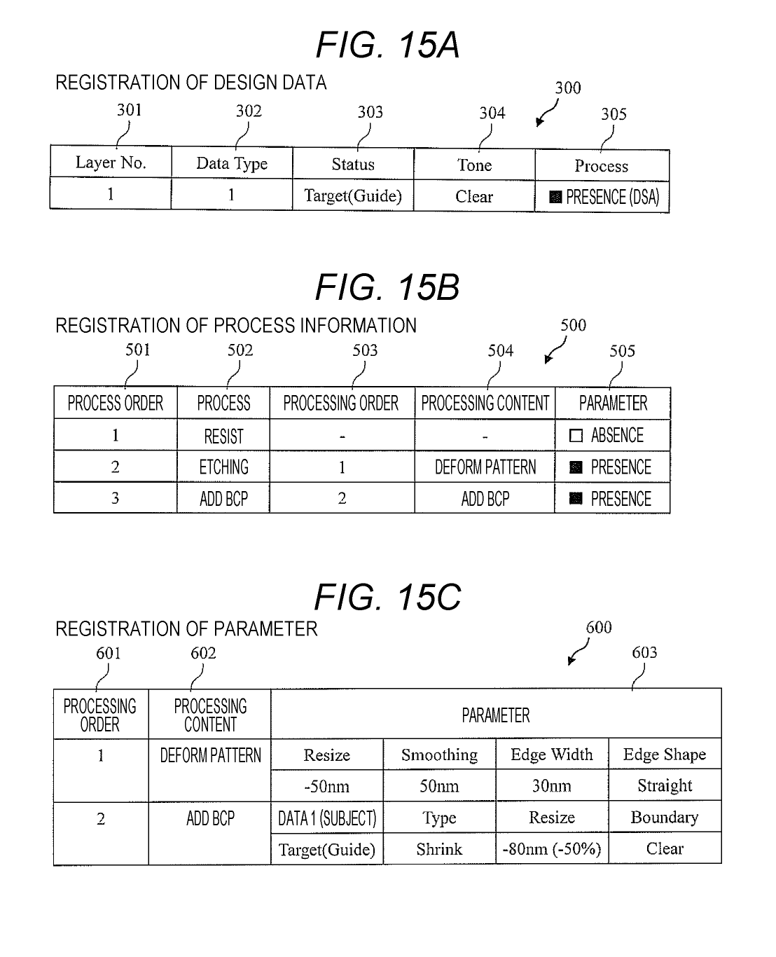

In a fourth embodiment, an example for creating a template of a pattern created by Direct-self assembly (DSA) will be described. FIG. 15A shows a registration example of the design data 300 of DSA. FIG. 15B shows a registration example of the process information 500 of DSA. The process information 500 is set such that “etching” and “addition of BCP” are executed for the design data 300 in this order.

FIG. 15C shows a registration example of the parameter information 600 of DSA. Parameter contents are the same as those of the previous embodiments. Description of parameter information sets which are already described will be omitted. In the parameter 603 of “addition of BCP”, subject data is set in “data 1 (subject)”, a type of a pattern (here, shrinking pattern (Shrink)) is set in “Type”, an amount of size deformation is set in “Resize”, and information of a boundary between a guide pattern and a BCP pattern is set in “Boundary”.

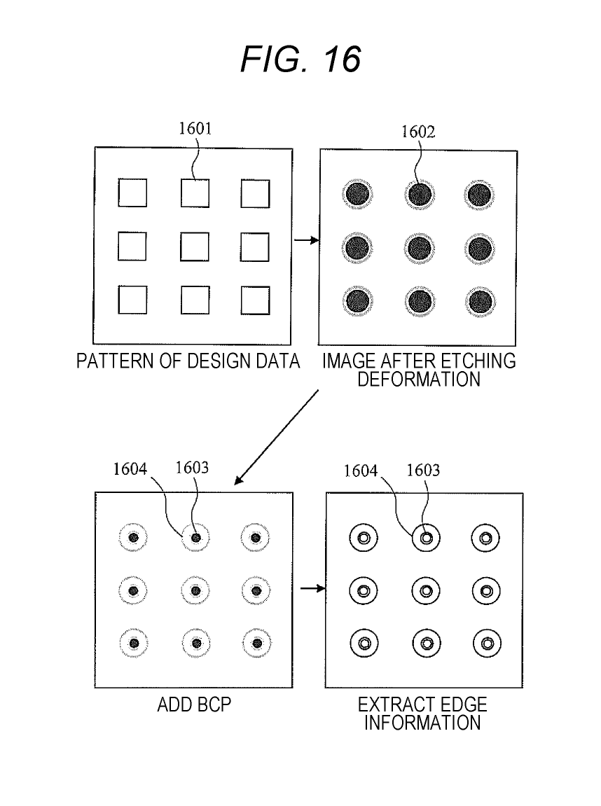

FIG. 16 shows a creation example of a template in the case of DSA. In the case of a pattern formed by Directed-Self assembly (DSA), a block polymer (BCP) is put into a guide pattern to form the pattern. A BCP portion in the guide pattern does not exist as design data in many cases. A pattern is detected by adding information of a pattern formed in the BCP portion into the guide pattern.

This embodiment shows a setting example of a shrinking process of a hole formed by putting BCP into a guide pattern of a hole. A main body of the following processings is the template creation unit 121 of the template creation device 120.

First, deformation processing is executed for design data 1601 of a guide pattern, and a guide pattern 1602 after etching is formed. Thereafter, a BCP pattern 1603 is added into the guide pattern 1602 which is subjected to deformation processing. In the example in FIG. 16, a pattern which is 50%-shrunken from the deformed guide pattern 1602 is added as the BCP pattern 1603.

In the parameter 603 of “addition of BCP”, when a boundary 1604 between the guide pattern 1602 and the BCP pattern 1603 can clearly be distinguished from each other, “Clear” is set in “Boundary”, and when the boundary 1604 cannot be distinguished, “None” is set in “Boundary”. According to this, it is possible to designate visibility manner of the boundary. In the example in FIG. 16, an image is formed so that the boundary 1604 can clearly be distinguished in accordance with the setting of the parameter 603 in FIG. 15C. The information of a pattern of the BCP portion may previously be stored in the storage unit 122 as a database and can be selected from the database.

Eventually, an image formed by extracting an edge from an image to which the BCP pattern 1603 is added is formed as a template. This embodiment shows an example of the shrinking process of the hole, but this embodiment can similarly be applied to a segmentalized process such as a line pattern. For example, in setting of the parameter 603 of “addition of BCP”, it is also possible to add a pattern of a segmentalized process of BCP into a guide pattern by setting “segmentalized” in “Type”.

According to this embodiment, process information concerning the DCP portion which does not exist in design data such as a CAD is registered, and a template is created using the process information. According to this, it is possible to create a template for DSA.

### Fifth Embodiment

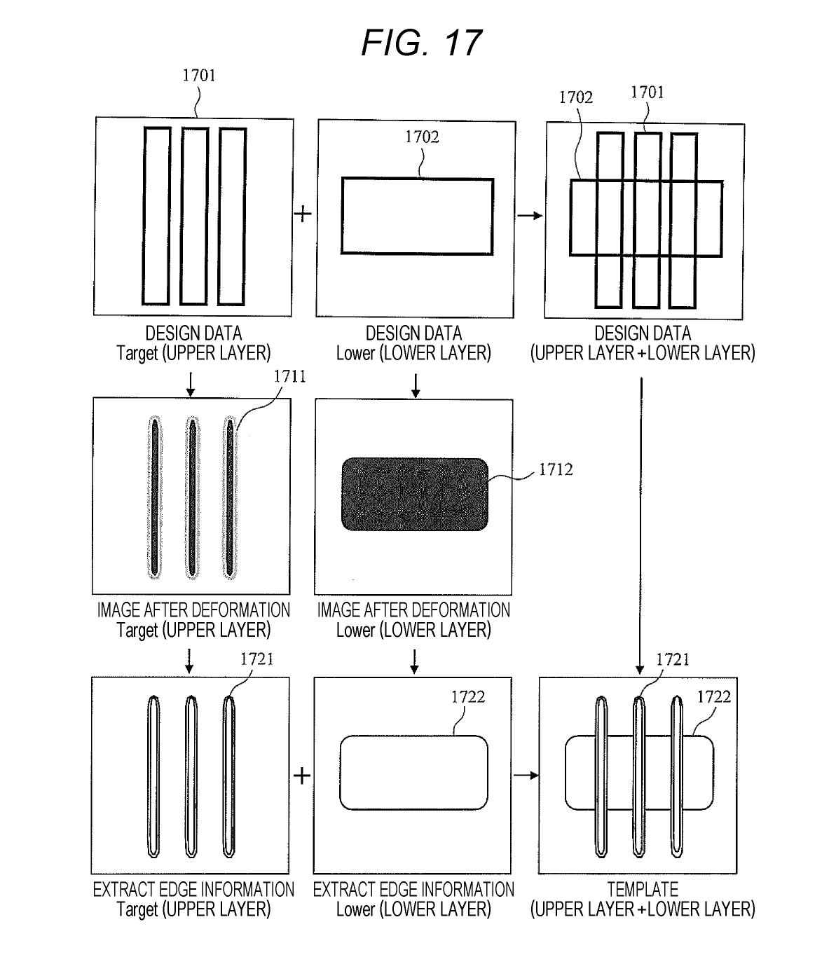

In a fifth embodiment, an example for creating a template by executing processing for a plurality of layers will be described. FIG. 17 shows an example for individually processing an upper layer (Target) and a lower layer (Lower). It is assumed that different process information sets 500 are registered for the upper layer (Target) and the lower layer (Lower).

In this case, deformation processing is first executed for design data 1701 of the upper layer (Target) to form a pattern 1711 after deformation. Thereafter, the pattern 1711 is subjected to edge extracting processing, and a pattern 1721 after edge extraction is created.

Next, deformation processing is executed for the design data 1702 of the lower layer (Lower), and a pattern 1712 after deformation is created. Then, edge extracting processing is executed for the pattern 1712, and a pattern 1722 after the edge extraction is created. Eventually, the pattern 1721 of the upper layer (Target) and the pattern 1722 of the lower layer (Lower) are superposed on each other, thereby creating a template. According to this embodiment, the upper layer (Target) and the lower layer (Lower) are separately processed, and information sets of the upper layer and the lower layer can be registered as a template.

The present invention is not limited to the above-described embodiments, and various modifications are included in the invention. For example, the above-described embodiments are described in detail so that the present invention can easily be understood, and the invention is not limited to one having all of the described configurations. A portion of a configuration of a certain embodiment can be replaced by a configuration of another embodiment, and a configuration of a certain embodiment can be added to a configuration of another embodiment. A configuration of one embodiment can be added to, deleted from and replaced by a portion of a configuration of another embodiment.

As described above, the present invention may be realized by a program code of software which realizes a function of the embodiment. In this case, an information processing device such as a computer is provided with a storage medium which stores a program code, and the information processing device (or CPU) reads the program code stored in the storage medium. In this case, the program code itself which is read from the storage medium realizes the functions of the above-described embodiments, and the program code itself and the storage medium which stores the program code configure the present invention. Examples of the storage medium used for supplying such the program code are a flexible disk, a CD-ROM, a DVD-ROM, a hard disk, an optical disk, a magnetic-optical disk, a CD-R, a magnetic tape, a non-volatile memory card and a ROM. A portion or all of the configurations of the embodiments may be realized by hardware by designing the configurations by an integrated circuit for example.

The program code of software which realizes the functions of the embodiments may be sent through a network, the program code may be stored in the storage medium such as the storage device of the information processing device or a storage medium such as the CD-RW and the CD-R, and when the program code is used, the CPU of the information processing device may read the program code stored in the storage device or the storage medium and may execute the program code.

A person skilled in the art will understand that there are a large number of combinations of hardware, software and firmware which are suitable for executing the present invention. For example, the program code for realizing the functions described in the embodiments can be realized by broad range program or script language such as assembler, C/C++, perl, Shell, PHP and Java (registered trademark).

Control lines and information lines in the drawings show matters which can be considered necessary for description, and all of control lines and information lines are not absolutely indicated in terms of a product. All of the configurations may be connected to each other.

### REFERENCE SIGNS LIST

101 design data

102 process information

103 processing

104 create template for image recognition

105 shot image

106 image recognition

110 sample observation device

111 pattern measurement unit

120 template creation device

121 template creation unit

122 storage unit

300 design data

401 design data of upper layer (Target)

402 design data of lower layer (Lower)

403 design data of removing region (Cut Mask)

500 process information

600 parameter information

901 pattern of design data

902 design data of removing region (Cut Mask)

911 pattern after deformation

912 pattern after portion of pattern is removed

913 information of removing region (Cut Mask)

1201 pattern of design data

1202 pattern after deformation

1203 spacer 1

1204 spacer 2

1401 pattern of core of design data

1402 pattern of core after deformation

1403 spacer 1

1404 spacer 2

1601 guide pattern of design data

1602 guide pattern after deformation

1603 BCP pattern

1604 boundary between guide pattern and BCP pattern

1. A template creation device for a sample observation device for creating a template for image processing using design data, the template creation device comprising:
a storage unit for storing process information in which information concerning a plurality of process processings is defined; and
a template creation unit for processing the design data using the process information and creating the template for the image processing.

2. The template creation device for a sample observation device according to claim 1, wherein the information concerning the plurality of process processings includes information concerning a processing order of a process, information concerning processing contents of the process, and information concerning a parameter of the process.

3. The template creation device for a sample observation device according to claim 1, wherein the information concerning the plurality of process processings includes at least one of process information sets comprising deformation, addition and removal of a pattern.

4. The template creation device for a sample observation device according to claim 3, wherein
the information concerning the plurality of process processings includes process information for adding a second pattern to a first pattern, and
the template creation unit creates the template in a form capable of distinguishing the first pattern and the second pattern from each other.

5. The template creation device for a sample observation device according to claim 4, wherein the template creation unit creates the template such that the first pattern and the second pattern are different from each other in contrast.

6. The template creation device for a sample observation device according to claim 3, wherein
the information concerning the plurality of process processings includes process information for adding a second pattern to a first pattern, and
the template creation unit deforms the second pattern in accordance with a shape of the first pattern when the second pattern is added such that it comes into contact with the first pattern as the processing.

7. The template creation device for a sample observation device according to claim 3, wherein
the information concerning the plurality of process processings includes process information for deforming or adding a first pattern and process information for removing a second pattern, and
the template creation unit executes any one of a first processing for deforming or adding the first pattern and then removing the second pattern, and a second processing for removing the second pattern and then deforming or adding the first pattern.

8. The template creation device for a sample observation device according to claim 3, wherein
the information concerning the plurality of process processings includes process information for removing a second pattern with respect to a first pattern, and
the template creation unit executes deformation processings which are different from each other in a region where a pattern is removed in the first pattern and a region where a pattern is not removed in the first pattern.

9. The template creation device for a sample observation device according to claim 8, wherein the region where the pattern is removed is an edge where a pattern is removed in the first pattern, and the region where the pattern is not removed is an edge where a pattern is not removed in the first pattern.

10. The template creation device for a sample observation device according to claim 2, wherein
the information concerning the plurality of process processings includes process information concerning a first layer and process information concerning a second layer located below the first layer, and
the template creation unit separately processes the first layer and the second layer, and superposes an image of the processed first layer and an image of the processed second layer on each other to create the template.

11. The template creation device for a sample observation device according to claim 2, wherein
the information concerning the parameter of the process includes information of a plurality of parameters concerning one parameter or includes information concerning variation of one parameter, and
the template creation unit creates the template and at least one more template using the plurality of parameters or the information concerning variation of the parameter.

12. The template creation device for a sample observation device according to claim 2, wherein the template creation unit creates the template and at least one more template by automatically changing information concerning a parameter of the process with a predetermined width.

13. The template creation device for a sample observation device according to claim 2, wherein the information concerning the parameter of the process is a shot image of the sample observation device and information extracted from the design data.

14. The template creation device for a sample observation device according to claim 1, further comprising a pattern detection unit for executing an image recognition processing for an image acquired by the sample observation device using the template.

15. The sample observation device according to claim 14, wherein the pattern detection unit executes at least one of processings which comprise deformation, addition and removal of a pattern with respect to the template acquired from the template creation device.

16. The sample observation device according to claim 15, wherein
the information concerning the plurality of process processings includes information of a process for removing a second pattern with respect to a first pattern,
the template creation unit forms an image of the first pattern and information concerning the second pattern as the template, and
the pattern detection unit executes the image recognition processing using a template in which the second pattern is removed from the image of the first pattern.
